(19) United States
(12) Patent Application Publication
(10) Pub. No.: US 2026/0032327 A1
(43) Pub. Date: Jan. 29, 2026

(54) VIDEO CAMERA VIEWFINDER

(71) Applicant: NIHON VIDEO SYSTEM CO., LTD., Tsushima-shi (JP)

(72) Inventors: Hideyuki NUKUMI, Tsushima-shi (JP); Kentaro HASHIGUCHI, Tsushima-shi (JP); Akikazu HASHIGUCHI, Tsushima-shi (JP)

(73) Assignee: NIHON VIDEO SYSTEM CO., LTD., Tsushima-shi (JP)

(21) Appl. No.: 19/266,040

(22) Filed: Jul. 10, 2025

(30) Foreign Application Priority Data
Jul. 23, 2024 (JP) 2024-118018

(51) Int. Cl. H04N 23/53

(52) U.S. Cl. CPC H04N 23/53

(57) ABSTRACT

The present invention aims to improve convenience and comfort. According to the present invention, the video camera viewfinder is provided with a tension adjustment mechanism on its movable portion, and HDMI and SDI video can be input. Furthermore, an input signal switch performs input switching or video switching based on a return switch signal. An LED light is provided at the bottom, and the LED light is adjusted as appropriate with a switch.

### CROSS-REFERENCE TO RELATED APPLICATION

This application is based upon and claims the benefit of priority from the prior Japanese Patent Application No. JP2024-118018, filed Jul. 23, 2024, which is incorporated by reference in its entirety for all purposes.

### BACKGROUND

### Field of the Invention

The present invention relates to a video camera viewfinder used in a video camera device.

### Description of the Related Art

When shooting with a video camera device, a cameraman grasps shooting status, VTR mode, remaining battery power, remaining recording media capacity, and other necessary information through characters or LED lamps displayed on or around the viewfinder image display unit. The cameraman appropriately adjusts the position and movable parts of the viewfinder to a style that is easy to use.

### PATENT LITERATURE

Patent Literature 1: Japanese Unexamined Patent Publication No. 2002-27294

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### Technical Problem

Viewfinders generally have constant torque for angle adjustment, and sometimes cannot be fixed if the internal rotating shaft loosens. Furthermore, the internal structure of the viewfinder itself is specialized depending on the manufacturer and lacks versatility. Currently, HDMI and SDI video signals are used, and compatibility is required.

The above circumstances have led to application of the present invention so as to improve the convenience and comfort.

### Solution to Problem

(1) A video camera viewfinder, comprising a viewfinder body, an eyepiece, and a tension adjustment mechanism configured to move a movable portion of the eyepiece up and down.

(2) The video camera viewfinder of (1), further comprising an input panel configured to change a viewfinder video input signal.

(3) The video camera viewfinder of (1) or (2), further comprising a liquid crystal monitor, wherein the video camera viewfinder is configured to input two or more video signals as a viewfinder video input signals and separately display different the video signals on a video display part of the eyepiece.

(4) The video camera viewfinder of any one of (1) to (3), configured to input two or more video signals as viewfinder video input signals and switch a video display on a video display part of the eyepiece.

(5) The video camera viewfinder of any one of (1) to (4), further comprising a bottom LED light at a bottom of the viewfinder body, and a changeover switch configured to switch whether to link lighting control of the bottom LED light with a TALLY signal.

(6) A video camera viewfinder, comprising a viewfinder body, an eyepiece, a tension adjustment mechanism configured to move a movable portion of the eyepiece up and down, a bottom LED light at a bottom of the viewfinder body, and a changeover switch configured to switch lighting control of the bottom LED light, wherein the changeover switch switches whether the bottom LED light is lit only when the TALLY signal is input or only when the TALLY signal is not input.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a perspective view of a video camera viewfinder according to a first embodiment of the present invention.

FIG. 2 is a front view of the video camera viewfinder of FIG. 1.

FIG. 3 is a right side view of the video camera viewfinder of FIG. 1.

FIG. 4 is a top view of the video camera viewfinder of FIG. 1.

FIG. 5 is a rear view of the video camera viewfinder of FIG. 1.

FIG. 6 is a bottom view of the video camera viewfinder of FIG. 1.

FIG. 7 is a perspective view of the video camera viewfinder of FIG. 1 seen from another angle.

### DETAILED DESCRIPTION

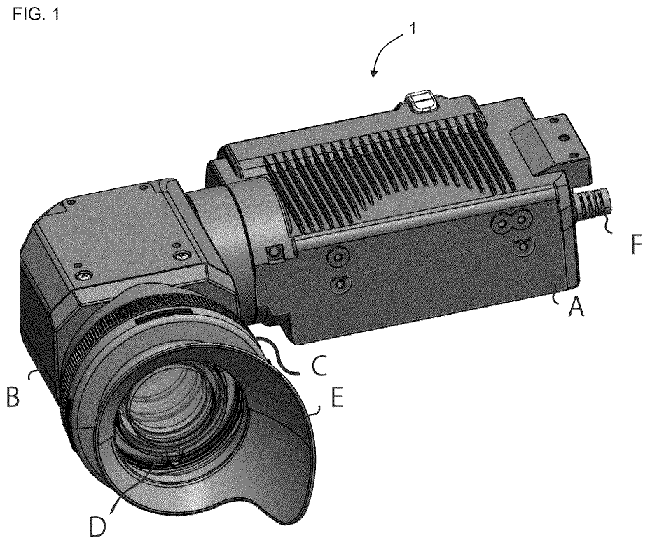

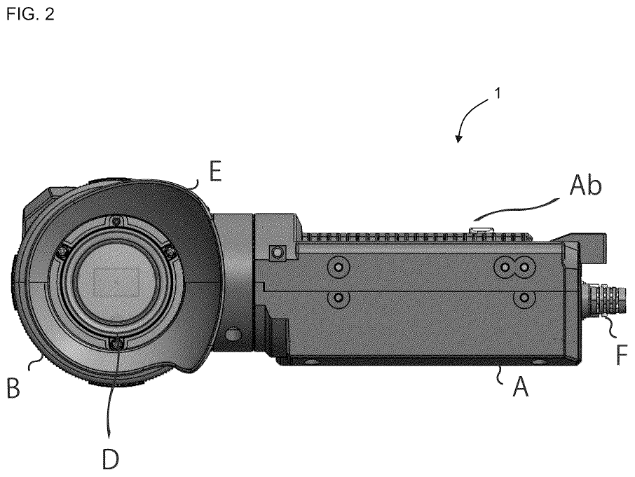

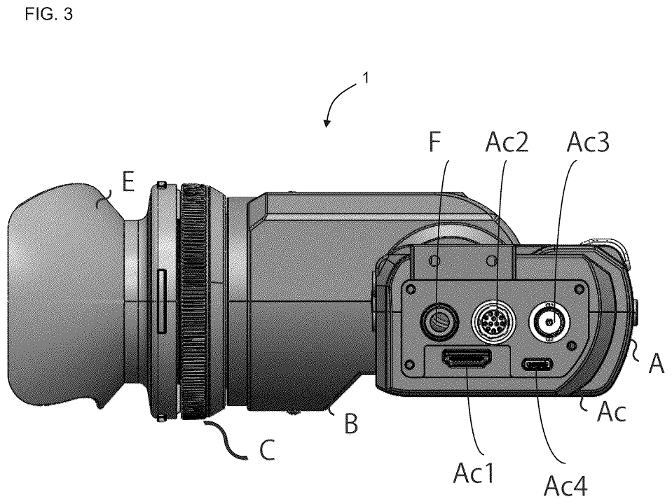

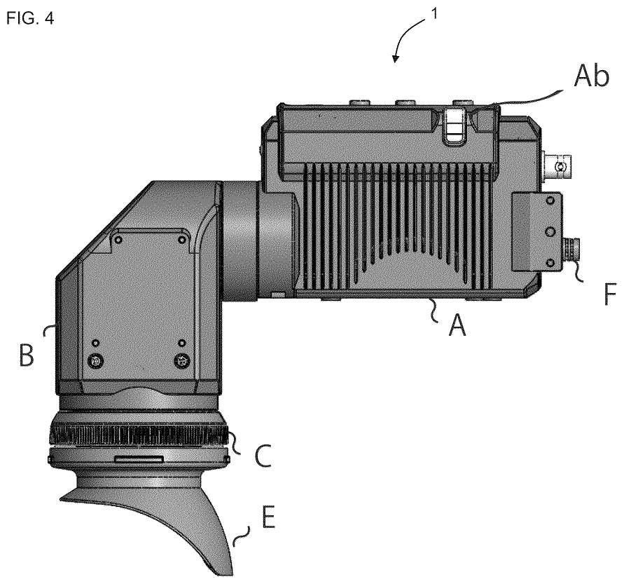

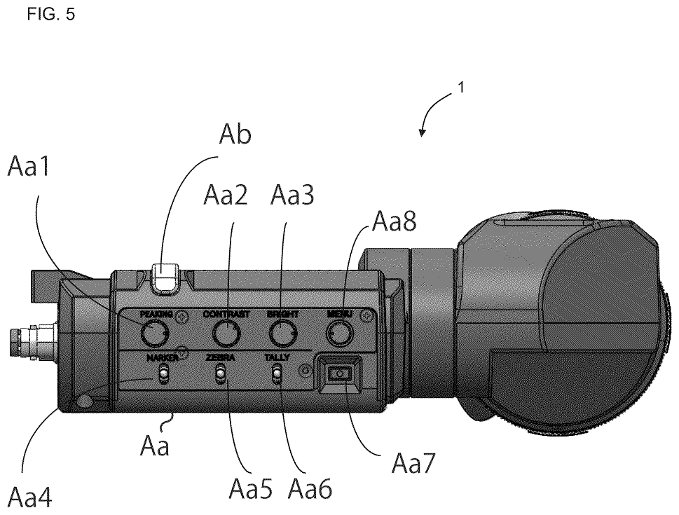

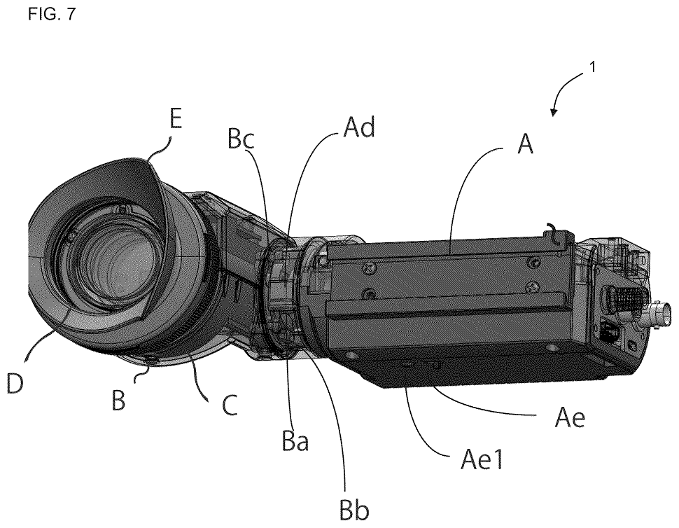

Hereinafter, a video camera viewfinder 1 according to a first embodiment of the present invention is described with reference to FIGS. 1 to 7.

The video camera viewfinder 1 of this embodiment comprises a viewfinder body A and an eyepiece B. The eyepiece B comprises a focusing ring C, a lens D, and an eyepiece cover E. The user typically brings their eye close to the eyepiece cover E and confirms the magnified image through the lens D. When in use, the angle of the eyepiece B is adjusted, and the user may lower the eyepiece B from vertical to about 135° toward the user side using the angle adjustment bracket Bc, depending on the application. At the joint between the viewfinder body A and the eyepiece B (hereinafter sometimes simply referred to as “joint”), the viewfinder body A includes a rotating shaft Ad, and the eyepiece B includes a rotating base Bb. A tension adjustment screw Ba is attached to the rotating base Bb, and by tightening the tension adjustment screw Ba, the tension for the angle adjustment is adjusted. In this way, a tension adjustment mechanism that moves the movable portion of the eyepiece B up and down is realized.

### Explanation of Claim 1

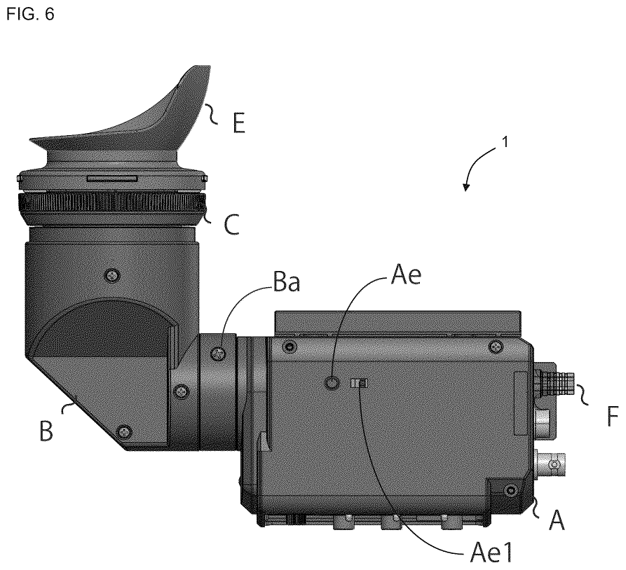

The tension is the torque related to the angle adjustment of the eyepiece B. As shown in FIG. 6, the tension adjustment screw Ba is attached to the rotating base Bb. The tension adjustment screw Ba is inserted from the outer surface of the rotating base Bb, from the outside toward the inside, centered on the rotating shaft Ad, when viewed from the direction along the rotating shaft Ad.

For example, when the tension adjustment screw Ba is tightened, the frictional force at the joint increases, and when the tension adjustment screw Ba is loosened, the frictional force at the joint decreases. At the joint, a rubber annular member (not shown) is arranged between the rotating base Bb and the viewfinder body A. When the tension adjustment screw Ba is tightened, the tip of the tension adjustment screw Ba presses the annular member toward the viewfinder body A. As a result, the frictional force at the joint increases. Conversely, when the tension adjustment screw Ba is loosened, the pressing of the annular member by the tension adjustment screw Ba is released. As a result, the frictional force at the joint decreases. In this way, the tension adjustment screw Ba adjusts the tension. However, the configuration of the video camera viewfinder 1 is not limited to the configuration described above. The tension adjustment screw Ba just needs to enable to adjust the tension.

The viewfinder body A includes a switch panel Aa. The switch panel Aa includes a PEAKING switch Aa1, a CONTRAST switch Aa2, a BRIGHT switch Aa3, a MARKER switch Aa4, a ZEBRA switch Aa5, a TALLY switch Aa6, an input switching switch Aa7, and a MENU switch Aa8. The input switching switch Aa7 switches input standards such as HDMI and SDI and displays the video on the video display part of the eyepiece B. In this way, the switch panel Aa functions as an input panel that enables to change a viewfinder video input signals.

### Explanation of Claim 2

The viewfinder body A includes a connector panel Ac. The connector panel Ac includes an HDMI connector Ac1, a lens return connector Ac2, a BNC connector Ac3, and a service connector Ac4. Through these connectors, two or more video signals can be input as the viewfinder video input signals. Furthermore, different video signals such as video return signals can be separately displayed on the video display part of the video eyepiece through the HDMI connector Ac1, the lens return connector Ac2, and the BNC connector Ac3.

### Explanation of Claim 3

A camera lens is connected to the lens return connector Ac2. The viewfinder body A receives a return switching signal sent from the camera lens via the lens return connector Ac2 and switches the video displayed on the video display part of the eyepiece B.

### Explanation of Claim 4

The video camera viewfinder 1 includes a bottom LED light Ae at the bottom of the viewfinder body A. The bottom LED light Ae is controlled by an LED switch Ae1 (a changeover switch). The LED switch Ae1 controls the bottom LED light Ae to light up only when a TALLY signal is input. The LED switch Ae1 controls the bottom LED light Ae to light up only when a TALLY signal is not input. The LED switch Ae1 controls the bottom LED light Ae to light up regardless of the ON/OFF state of the TALLY signal. The LED switch Ae1 controls the bottom LED light Ae not to light up.

### Explanation of Claim 5

For example, in order to prevent the subject from being aware of the shooting, it is conceivable to control the lighting and extinguishing of the bottom LED light by user operation. However, when the user extinguishes the bottom LED light by operation, there is a possibility that the user may have difficulty intuitively judging whether or not the TALLY signal is input. In this embodiment, the changeover switch switches whether the bottom LED light is lit only when the TALLY signal is input or only when the TALLY signal is not input. When the bottom LED light is lit only when the TALLY signal is not input, in addition to being able to prevent the subject from being aware of the shooting, it is easier for the user to intuitively judge whether or not the TALLY signal is input. Furthermore, the lighting mode of the bottom LED light can be easily changed by the changeover switch depending on whether the state is one in which the user does not want the subject to be aware of shooting, or other states.

1: Video camera viewfinder, A: Viewfinder body, Aa: Switch panel, Aa1: PEAKING switch, Aa2: CONTRAST switch, Aa3: BRIGHT switch, Aa4: MARKER switch, Aa5: ZEBRA switch, Aa6: TALLY switch, Aa7: Input switching switch, Aa8: MENU switch, Ab: TALLY display unit, Ac: Connector panel, Ac1: HDMI connector, Ac2: Lens return connector, Ac3: BNC connector, Ac4: Service connector, Ad: Rotating shaft, Ae: Bottom LED light, Ae1: LED switch (changeover switch), B: Eyepiece. Ba: Tension adjustment screw. Bb: Rotating base. Bc: Angle adjustment bracket. C: Focusing ring. D: Lens. E: Eyepiece cover. F: Cable.

While illustrative embodiments have been illustrated and described, it will be appreciated that various changes can be made therein without departing from the spirit and scope of the invention.

The embodiments of the invention in which an exclusive property or privilege is claimed are defined as follows:

1. A video camera viewfinder, comprising:
a viewfinder body;
an eyepiece; and
a tension adjustment mechanism configured to move a movable portion of the eyepiece up and down.

2. The video camera viewfinder of claim 1, further comprising an input panel configured to change a viewfinder video input signal.

3. The video camera viewfinder of claim 1, further comprising a liquid crystal monitor, wherein the video camera viewfinder is configured to input two or more video signals as a viewfinder video input signals and separately display different the video signals on a video display part of the eyepiece.

4. The video camera viewfinder of claim 1, configured to input two or more video signals as viewfinder video input signals and switch a video display on a video display part of the eyepiece.

5. The video camera viewfinder of claim 1, further comprising:
a bottom LED light at a bottom of the viewfinder body, and
a changeover switch configured to switch whether to link lighting control of the bottom LED light with a TALLY signal.

6. A video camera viewfinder, comprising:
a viewfinder body,
an eyepiece,
a tension adjustment mechanism configured to move a movable portion of the eyepiece up and down,
a bottom LED light at a bottom of the viewfinder body, and
a changeover switch configured to switch lighting control of the bottom LED light,
wherein
the changeover switch switches whether the bottom LED light is lit only when a TALLY signal is input or only when the TALLY signal is not input.
